(19) United States
(12) Patent Application Publication
(10) Pub. No.: US 2008/0101476 A1
(43) Pub. Date: May 1, 2008

(54) VIDEO CODING RATE ADAPTATION TO REDUCE PACKETIZATION OVERHEAD

(75) Inventors: Tao Tian, San Diego, CA (US); Vijayalakshmi R. Raveendran, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 11/555,632

(22) Filed: Nov. 1, 2006

(51) Int. Cl. H04N 7/12

(52) U.S. Cl. 375/240.26

(57) ABSTRACT

This disclosure describes techniques for video coding rate adaptation to reduce packetization overhead. The video coding rate controls the number of coding bits allocated to a segment of encoded video, and hence the length of the encoded video segment. Differences between the length of the encoded video segment and the cumulative length of a series of packets used to encode the video segment result in unused packet space within the last packet in the series. This unused packet space is typically filled with padding bits. In accordance with the disclosure, the video coding rate is adjusted for a segment of digital video so that the encoded video more closely fits within the series of packets, thereby reducing the number of padding bits required by the last packet.

### TECHNICAL FIELD

This disclosure relates to digital video coding and, more particularly, techniques for controlling video coding rate.

### BACKGROUND

Digital video capabilities can be incorporated into a wide range of devices, including digital televisions, digital direct broadcast systems, wireless communication devices, personal digital assistants (PDAs), laptop computers, desktop computers, video game consoles, digital cameras, digital recording devices, cellular or satellite radio telephones, and the like. Digital video devices can provide significant improvements over conventional analog video systems in processing and transmitting video sequences.

Different video encoding standards have been established for encoding digital video sequences. The Moving Picture Experts Group (MPEG), for example, has developed a number of standards including MPEG-1, MPEG-2 and MPEG-4. Other examples include the International Telecommunication Union (ITU)-T H.263 standard, and the emerging ITU-T H.264 standard and its counterpart, ISO/IEC MPEG-4, Part 10, i.e., Advanced Video Coding (AVC). These video encoding standards support improved transmission efficiency of video sequences by encoding data in a compressed manner.

Rate control techniques are used to adjust the number of coding bits, i.e., the coding rate, allocated to each video frame. Coding rates may be adjusted to ensure that the encoded video sequence conforms to quality requirements and/or bandwidth limitations. Some rate control techniques are designed to produce a constant coding rate, while other rate control techniques are designed to produce constant quality. Other rate control techniques may balance coding rate and quality level, and be responsive to video frame content.

In a packet-switched network, wired or wireless, the encoded video is packetized for transmission. Applicable network protocols typically specify a packet size requirement. For example, the transmission control protocol (TCP) used for Internet transmission specifies a maximum transmission unit (MTU). Given a specified packet size, a burst of encoded video may be divided into multiple packets for transmission over the network. In general, the size of the burst may not match the size of the packets exactly. For this reason, the last packet ordinarily will include at least some padding bits.

### SUMMARY

This disclosure describes techniques for video coding rate adaptation to reduce packetization overhead. The video coding rate controls the number of coding bits allocated to a segment of encoded video, and hence the length of the encoded video segment. Differences between the length of the encoded video segment and the cumulative length of a series of packets used to encode the video segment result in unused packet space within the last packet in the series. This unused packet space is typically filled with padding bits. In accordance with the disclosure, the video coding rate is adjusted for a segment of digital video so that the encoded video more closely fits within the series of packets, thereby reducing the number of padding bits required by the last packet.

In one aspect, the disclosure provides a video encoding method comprising determining a size of a packet used to packetize an encoded segment of digital video data, and selecting an encoding rate for the segment of digital video data based on the packet size.

In another aspect, the disclosure provides a digital video encoding apparatus comprising a rate control unit that determines a size of a packet used to packetize an encoded segment of digital video data, and selecting an encoding rate for the segment of digital video data based on the packet size.

In an additional aspect, the disclosure provides a processor for encoding digital video data, the processor being configured to determine a size of a packet used to packetize an encoded segment of digital video data, and select an encoding rate for the segment of digital video data based on the packet size.

The techniques described in this disclosure may be implemented in a digital video apparatus in hardware, software, firmware, or any combination thereof. If implemented in software, the software may be executed in a machine such as a processor. The software may be initially stored as instructions in a machine-readable medium and executed by the machine to support video coding rate adaptation to reduce packetization overhead, in accordance with this disclosure.

Additional details of various aspects are set forth in the accompanying drawings and the description below. Other features, objects and advantages will become apparent from the description and drawings, and from the claims.

### BRIEF DESCRIPTION OF DRAWINGS

FIG. 1 is a block diagram illustrating a digital video processing apparatus employing video coding rate adaptation to reduce packetization overhead according to an aspect of this disclosure.

FIG. 2 is a diagram illustrating packetization of a video segment with a coding rate resulting in substantial packetization overhead.

FIG. 3 is a diagram illustrating packetization of a video segment with an adapted packet rate, in accordance with this disclosure, resulting in reduced packetization overhead.

FIG. 4 is a graph illustrating a distribution of video segment remainder sizes over a video sequence concatenated by several different types of content.

FIGS. 5 and 6 are graphs illustrating a function for controlling encoding rate to reduce packetization overhead.

FIG. 7 is a flow diagram illustrating a method for video coding rate adaptation to reduce packetization overhead according to an aspect of this disclosure.

FIG. 8 is a flow diagram illustrating use of historical data to adjust the video coding rate in the method of FIG. 7.

### DETAILED DESCRIPTION

This disclosure describes techniques for video coding rate adaptation to reduce packetization overhead. The video coding rate controls the number of bits allocated to frames in a segment of encoded video, and hence the length of the encoded video segment. Differences between the length of the encoded video segment and the cumulative length of a series of packets used to encode the video segment result in unused packet space within the last packet in the series. This unused packet space is typically filled with padding bits, resulting in wasted bandwidth.

In accordance with the disclosure, the video coding rate is adjusted for frames in a segment of digital video so that the encoded video more closely fits within the series of packets, thereby reducing the number of padding bits required by the last packet. For example, the portion of the segment falling in the last packet, i.e., the remainder, may be maximized, or at least increased, to more closely match the size of the last packet, leaving less empty space for padding bits.

In general, in some aspects, the encoding rate may be selected based on an estimated variance of the rate control algorithm used to control the coding rate for the segment, and historical data indicating a mean value of the remainder for previously encoded segments of digital video data. The video coding rate adaptation techniques are adaptive to different video content, may require low computation complexity, and may be characterized by multiple parameters than can be fine tuned for different rate control algorithms.

The techniques may be used with any of a variety of predictive video encoding standards, such as the MPEG-1, MPEG-2, or MPEG-4 standards, the ITU H.263 or H.264 standards, or the ISO/IEC MPEG-4, Part 10 standard, i.e., Advanced Video Coding (AVC), which is substantially identical to the H.264 standard. For example, a technique for video coding rate adaptation, as described in this disclosure, may be used in conjunction with a standard rate control algorithm to adjust the rate for enhanced packetization overhead efficiency. In some aspects, a technique for video coding rate adaptation may be used to adjust a coding rate generated by a standard rate control algorithm. The standard rate control algorithm may be a constant rate or variable rate algorithm.

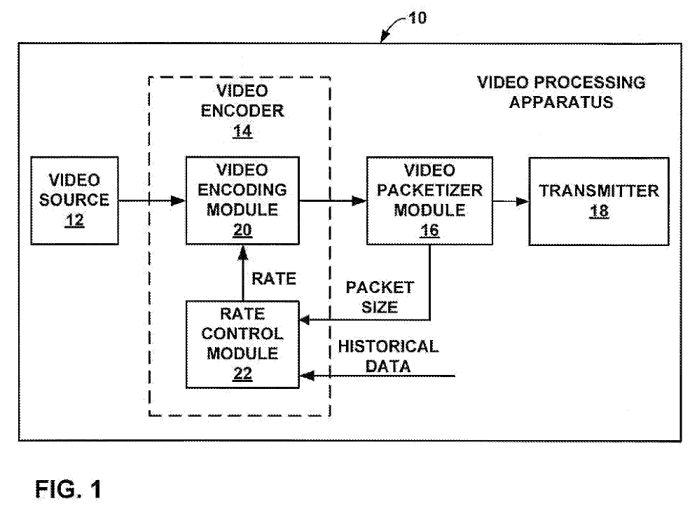

FIG. 1 is a block diagram illustrating an example digital video processing apparatus 10. In the example of FIG. 1, video processing apparatus 10 includes a video source 12, a video encoder 14, a video packetizer 16 and a transmitter 18. Video processing apparatus 10 may reside within any device capable of encoding and transmitting video data, such as a video camera, digital direct broadcast system, a wireless communication device, such as cellular or satellite radio telephone, a personal digital assistant (PDA), a laptop computer, a desktop computer, a video game console, or the like.

Video source 12 may be a video capture device such as a video camera, or a video archive that stores previously captured digital video. Video source 12 also may be an interface to a live or archived video feed. Video encoder 14 includes a video encoding module 20 that encodes video obtained from video source 12 according to any of a variety of video coding standards, such as H.264, as mentioned above. In addition, video encoder 14 includes a rate control module 22 that controls the coding rate applied by video encoding module 20 to encode frames within a video segment. The coding rate specifies the number of coding bits allocated to the frames in the video segment.

Video packetizer 16 receives the encoded video segment from video encoding module 18 and divides the encoded video segment into a series of packets for transmission via transmitter 16. The resulting packets may be passed from the application layer to other layers, such as the transport and physical layers, for further processing, such as multiplexing, additional packetization, and other operations.

Each packet generated by video packetizer 16 may include a portion of a segment of encoded video data, as well as any applicable header data. In particular, each packet may carry one or more frames from the video segment. The last packet in the series of packets used to encode a video segment will carry the “remainder” of the video segment, i.e., the remaining portion that did not fit into the previous packets in the series, plus empty space occupied by padding bits.

In some cases, encoded video data produced by video encoding module 20 may be archived prior to video packetization, e.g., in memory or data storage within video processing apparatus 10. Alternatively, packetized video produced by video packetizer 16 may be archived, rather than immediately transmitted. In either case, transmitter 18 may be any suitable transmitter capable of transmitting packets produced by video packetizer 16 over a wired or wireless communication medium, such as a packet-switched network.

Video encoding module 20 generates segments of encoded video data in bursts. Due to its “bursty” nature, a compressed video stream has a time-variant bandwidth. In the case of the H.264 standard, for example, each segment of video data processed by video encoding module 20 may be a so-called superframe (SF), which generally constitutes a one-second burst of video data. The SF may carry multiple frames of video data. For example, in some applications, an SF may carry approximately 30 frames. The frames are sequential image in a video sequence, and may be intra-coded as I frames, inter-coded as P frames, or inter-coded as bi-directional (B) frames.

Frames may be different sizes, and a packet may carry one or more frames. For this reason, each segment of the video data, e.g., each SF, may have a different size, in terms of the number of bits associated with the content in the video data segment. The number of coding bits allocated to each frame also may be different. Moreover, the number of coding bits allocated across the frames in a segment, i.e., the coding rate for the segment, differs as a function of the rate control adaptation techniques described in this disclosure.

The size of a segment of video data containing a relatively high complexity scene typically will be larger than the size of a segment of video data containing a relatively low complexity scene. In addition, the size of individual frames within the segment may vary according to complexity. For example, some frames may include more motion or more complex texture than other frames. In any event, the size of each frame and the size of the segment containing multiple frames will vary from frame to frame and segment to segment. For these reasons, a variable rate control algorithm will allocate different coding rates to different segments.

Each packet generated by video packetizer 16 may have a fixed size, or a variable size subject to some constraints. For example, applicable network protocols typically set a maximum packet size requirement, such as the MTU specified for TCP. Given a specified packet size, a segment of video encoded by video encoder 14 is divided into multiple packets by video packetizer 16 for transmission over the network. In general, the size of the encoded video produced by video encoding module 20 will not exactly match the size of the packets produced by packetizer 16 and, as mentioned above, will be time variant.

Due to the mismatch between the size of the encoded video segment and the cumulative size of the several packets needed to carry the encoded video segment, the last packet produced by packetizer 16 ordinarily will include at least some padding bits. The padding bits fill the empty space resulting from the mismatch between the size of the encoded video and the cumulative size of the packets. The inclusion of padding bits is inefficient, resulting in consumption of bandwidth that could be used for other purposes. In accordance with this disclosure, rate control module 22 adjusts the coding rate applied by video encoding module 20 to encode frames in the video segment in a manner formulated to reduce the number of padding bits required by packetizer 16. In this manner, packet-based coding and communication of video data can be made more efficient.

Rate control module 22 may apply a standard rate control algorithm that is biased to reduce packetization overhead, in accordance with this disclosure. For example, rate control module 22 determines the size of packets used to packetize the encoded digital video data produced by video encoding module 20. Rate control module 22 may receive the packet size from video packetizer 22, as shown in FIG. 1. The packet size may be fixed or variable, and specified by video packetizer 22 on a packet-by-packet, periodic or intermittent basis. Alternatively, the packet size may be fixed and known by rate control module 22. In either case, rate control module 22 obtains the size or sizes of the video packets to be used to packetize the encoded video segment.

In addition, rate control module 22 may receive historical data indicating a mean remainder for previously encoded segments of digital video data. Based on the packet sizes and/or the historical information, rate control module 22 selects the encoding rate to be used by video encoding module 20 for the current segment of digital video data to be encoded. The encoding rate may change from segment to segment. In particular, the encoding rate set by rate control module 22 may change as a function of the size of the current segment to be encoded, such that rate control module 22 adapts the video coding rate on a segment-by-segment basis to reduce packetization overhead. In this manner, rate control module 22 can adapt to changes in video content from segment to segment.

Using the selected coding rate, video encoding module 20 encodes the video data segment to more closely match the cumulative size of a series of packets used to carry the encoded video data segment. In this manner, rate control module 22 reduces packetization overhead and promotes bandwidth efficiency. Bandwidth efficiency may be important for any communication medium, but is especially important for a wireless communication medium with limited bandwidth. Moreover, bandwidth efficiency may be a significant concern for applications involving real-time transmission of video sequences over a wireless channel.

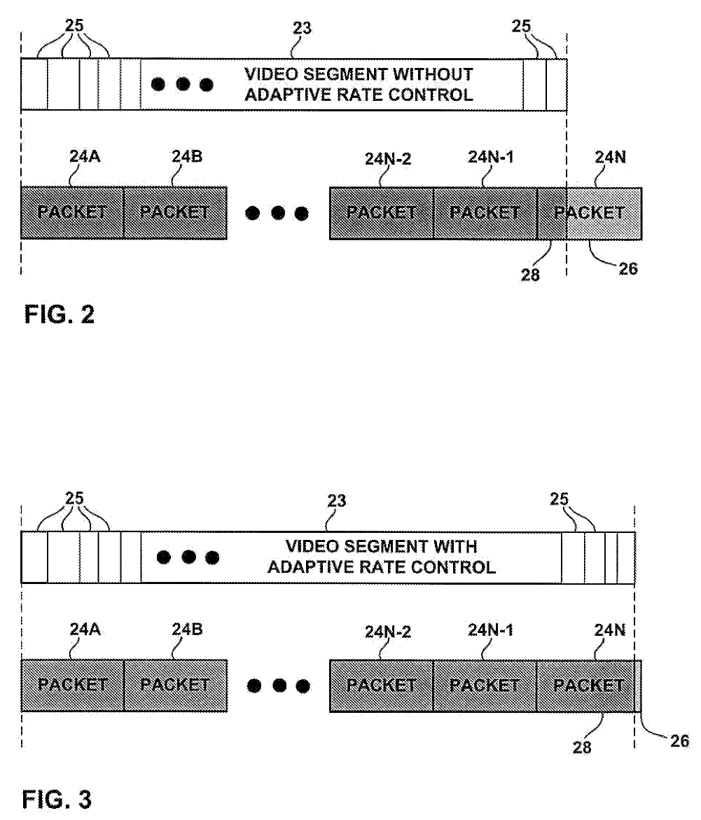

FIG. 2 is a diagram illustrating packetization of a video segment with a coding rate resulting in substantial packetization overhead. As shown in FIG. 2, encoding module 20 encodes a segment 23 of digital video data. Segment 23 may be referred to as a superframe (SF) for purposes of illustration, but without limitation. The techniques described herein could be applied to any sized segment. Again, an SF typically refers to a segment of approximately thirty consecutive frames of a video sequence, although the number of frames will vary from SF to SF.

In the example of FIG. 2, encoding module 20 codes segment 23 at a given coding rate, e.g., using a standard rate control algorithm, without regard to the size of the encoded segment 23 relative to packets used to packetize the segment. Packetizer 16 divides segment 23 among an integer number of packets 24A-24N (collectively packets 24). Each packet 24 carries a portion of encoded video segment 23, and also may carry an amount of header information or other administrative data. Video segment 23 is encoded to include multiple frames 25 of video data. Each packet 24 may carry multiple encoded frames 25.

Because the cumulative size of the series of packets 24A-24N is larger than the size of the encoded video segment 23, the last packet 24N has a significant amount of empty space 26, which packetizer 16 fills with padding bits. In other words, the last remaining portion of encoded video segment 23 fills only a portion 28 of the last packet 24N, leaving empty space 26 that is wasted and filled with padding bits. The amount of empty space 26 varies from segment to segment as the size of the current video segment changes. In each case, however, there will typically be empty space 26 of some amount, resulting in inefficient bandwidth utilization.

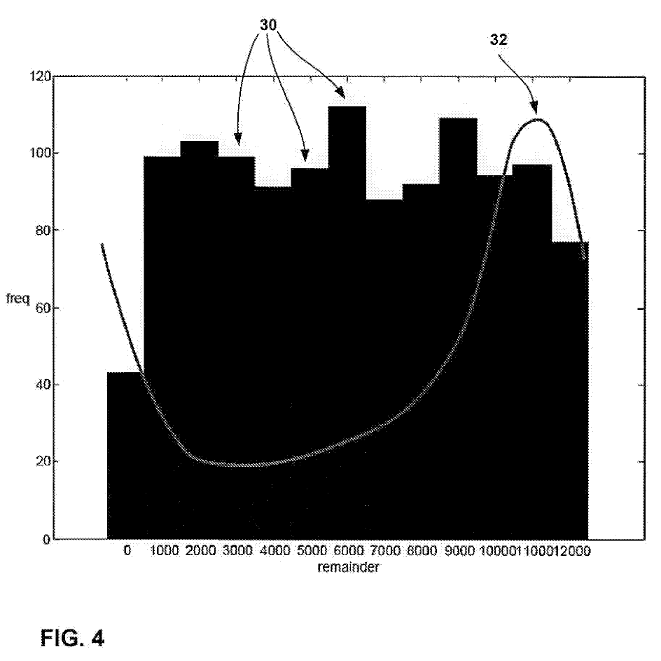

FIG. 3 is a diagram illustrating packetization of a video segment with an adapted packet rate, in accordance with this disclosure, resulting in reduced packetization overhead. The diagram of FIG. 3 substantially conforms to that of FIG. 2. However, in the example of FIG. 3, rate control module 22 adjusts the encoding rate for frames 25 carried in the video segment 23 based on the size of each packet 24A-24N to produce an encoded video segment 23 that more closely matches the cumulative size of packets 24A-24N. In this case, encoding module 20 codes frames 25 in segment 23 at a coding rate that is selected to more efficiently utilize packet bandwidth. For example, rate control module 22 can be configured to modify a standard rate control algorithm so that packetization overhead can be reduced.

In selecting the adapted encoding rate, rate control module 22 takes into account the size of each packet 24A-24N and, optionally, the amount of each packet consumed by header or any other administrative information. Rate control module 22 is designed to select a coding rate that causes the encoded video segment to fit into an integer number of packets 24 without requiring substantial padding bits. The number of packets required to carry the encoded video segment 23 is not particularly important. Rather, the feature of interest is the size of the segment remainder in the last packet. In some cases, the reduction in padding bits can directly result in slight quality improvements in the coding of frames within a given segment. In other cases, quality may be reduced slightly to ensure that a segment of frames fits into a packet without substantial padding.

In general, rate control module 22 may be designed to favor slight undershoot rather than slight overshoot of an integer number of packets, such that rate control module 22 drives the encoding rate to produce relatively large remainders. In turn, relatively large remainders produce relatively small amounts of empty space in the last packet, promoting enhanced bandwidth utilization. As will be described, to bias the rate control algorithm to produce larger remainders, rate control module 22 may consider an estimated variance of the rate control algorithm, e.g., in terms of its accuracy in terms of the difference between allocated bits and actual bits for previously encoded segments. In addition, rate control module 22 may consider historical data indicating a mean value of the remainder for previously encoded segments of digital video data.

In considering the cumulative size of the packets 24, rate control module 22 may assume a fixed size for each packet, or variable packet sizes. A fixed size will be assumed in this disclosure for purposes of illustration, but without limitation of the rate control techniques as broadly embodied and described. Again, the disclosure may be applicable to variable packet sizes that vary on a packet-by-packet basis or on a periodic or intermittent basis. Notably, the number of packets in a series of packets used to packetize a video segment need not be fixed, and typically will not be fixed, but rather variable as a function of the coding rate and complexity of the segment to be encoded. Accordingly, rate control module 22 may select the coding rate in a manner that reduces the packetization overhead for a variable number of packets of fixed size.

Rate control module 22 may apply an algorithm generally as described below. For example, to illustrate an exemplary rate control algorithm that may be implemented by rate control module 22, it is assumed that every one second of digital video is transmitted as a burst, which may be referred to as a superframe (SF). The number of bits b in the k^{th} SF is b(k). For packetization, it is further assumed that the b(k) bits in the k^{th} SF need to be split into packets of u bits each. In other words, each packet includes u bits of space, exclusive of header and other administrative information, to carry a portion of the k^{th} SF, which may include one or more encoded frames.

The last packet in the series of packets used to carry the k^{th} SF may be padded to make u bits. Therefore, the actual number of bits B (including coded video bits and padded bits) transmitted for the k^{th} SF is:

$$B ( k ) = ceiling ( \frac{b ( k )}{u} ) \times u , \qquad ( 1 )$$

where ceiling represents the ceiling function, which yields the minimum integer that is greater than or equal to the variable. Hence, when applied to b(k)/u, the ceiling function yields the number of packets needed to carry the bits of the k^{th} SF, while B(k) is the total number of bits in the entire series of packets, including video bits and padding bits. To reduce packetization overhead, fewer padding bits should be used.

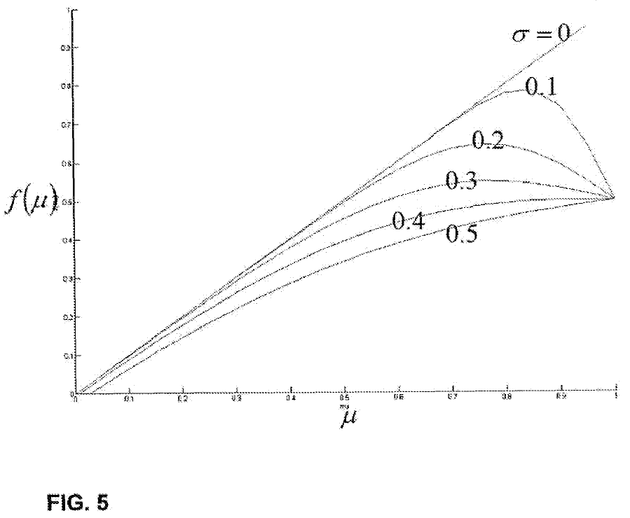

FIG. 4 is a graph illustrating a distribution of encoded video segment sizes over a long video test sequence concatenated by several different types of content, such as animation, music video, news and sports. The data in FIG. 4 is an example of historical data that can be evaluated to estimate a mean remainder for previously encoded segments. Each segment may be referred to as a superframe (SF), and may be assumed to include a one-second burst of video data. In the example of FIG. 4, the video segments were encoded at a nominal rate of 256 kilobits per second (Kbps).

In FIG. 4, vertical bars 30 show the segment size distribution, with modulo u=12 Kbits. Hence, for purposes of FIG. 4, it is assumed that each packet has 12 Kbits to accommodate at least a portion of the SF, e.g., one or more frames. The x axis (remainder) in FIG. 4 represents the number of SF bits in excess of the cumulative number of bits available in an integer number of packets. In other words, the x axis represents the number of remainder bits that would be filled by the SF in the last packet. The x axis therefore also indicates, indirectly, the number of padding bits that would be need to be added to the SF bits in order to completely fill that packet, and provides an indication of packetization overhead.

The y axis (freq) represents the number of video segments, in the subject video test sequence, having a number of bits that produces the remainder level shown on the x axis. For example, the graph in FIG. 4 shows that there are approximately 42 SF's in the test sequence that yield a remainder of zero because the number of bits in each of those SF's exactly matches the number of bits available in an integer number of packets. In contrast, there are approximately 112 SF's in the test sequence that yield a remainder of approximately 6000bits. Because each packet provides 12 Kbits to accommodate the SF, the remaining 6000 bits fill one-half of the last packet. Consequently, the last packet requires 6000 additional padding bits to fill the empty space in the packet. Similarly, there are approximately 108 SF's having a remainder level of 9000 bits, such that the last packet requires 3000 padding bits to fill the entire 12Kbits in the packet

It can be seen from FIG. 4 that the remainder distribution among the segments is close to a uniform distribution. To reduce packetization overhead, however, it is desirable to adapt the applicable rate control algorithm to change the above distribution. In particular, it is desirable to change the distribution so that it more closely conforms to curve 32 in FIG. 4. With proper rate control, curve 32 provides a much larger distribution of SF remainders that are either zero or closely match the size of the last packet, e.g., 12 Kbps. In other words, consistent with curve 32, it is desirable that a SF have either a zero remainder, such that the last packet is entirely filled and no additional packets needed, or a very large remainder such that the last packet is nearly filled and requires very few padding bits.

In addition, per curve 32, the distribution of SF's with small to medium sized remainders is substantially reduced. The left-most side of the curve represents a slight overshoot, whereas the right-most side of the curve represents a slight undershoot. Exact matching requires no padding bits. A slight undershoot requires very few padding bits, which is desirable of purposes of bandwidth efficiency. A slight overshoot, in contrast, requires a large number of padding bits, and creates a significant waste of bandwidth. As an example, a slight undershoot resulting from a remainder of 11000 video bits would require only 1000 padding bits, given the 12 Kbits space provided by each packet. In contrast, a slight overshoot would yield a very small remainder that requires an undesirably large number of padding bits. For example, a slight overshoot of 1000 video bits would require that the last packet include 11000 padding bits.

By controlling the encoding rate based on packet sizes, an estimated variance, and a mean remainder, rate control module 22 (FIG. 1) can adjust the SF distribution to produce more large sized remainders that slightly undershoot the packet size, and thereby reduce wasted packet space that is filled by padding bits. A set of test data as shown in FIG. 4, representing historical mean remainder data over a series of previously encoded segments, can be established once, and evaluated to define the adaptation function for rate control to reduce packetization overhead, e.g., prior to use of the video processing apparatus. In this case, the mean used for adaptive rate control may be based on a static set of historical data that is predictive of video segments to be handled by video encoder 14. Alternatively, the historical data may be updated over time for actual video segments handled by video encoder such that the adaptive rate control dynamically changes according to the mean remainder over a sequence of previously encoded video segments.

As one example, the historical data may be established for an individual video processing apparatus or established for a class or category of video processing apparatus. In either case, the adaptation function generated from analysis of the data may be loaded into the video processing apparatus, e.g., at the “factory.” Alternatively, or additionally, a set of test data may be obtained from actual video data and analyzed periodically during operation of video processing apparatus 10 so that the function can be periodically updated or calibrated to actual video content handled by the video processing apparatus. As a further alternative, as mentioned above, the mean remainder value may be analyzed periodically or substantially continuously, e.g., over a sliding window of encoded video segments, so that rate control module 22 adapts to the actual remainder values produce for previously encoded video segments.

The historical data may be provided as an input to rate control module 22, e.g., as a set of data indicating remainder values or as pre-processed values indicating a mean value. To that end, functionality for dynamic analysis of mean remainder value may be provided in a separate component of video encoder 14 or integrated within rate control module 22. In either case, video packetizer module 16 may be equipped to indicate the number of padding bits required for packetization of each encoded video segment, and hence the remainder value for each video segment.

The analysis and processing of historical data for definition of the adaptation function will be described with further reference to the example of FIG. 4. For a data set such as that shown in FIG. 4, the probability distribution of curve 32 can be characterized by the following equation:

$$p ( x ) = 1 - A + A {\sum }_{n = - ∞}^{∞} {N}_{x} ( μ - n , {σ}^{2} ) \\ 0 \leq μ \leq 1 \\ 0 \leq x \leq 1 , \qquad ( 2 )$$

where x is the SF remainder on the x axis, A is a model parameter that can be selected based on simulation, and:

$${N}_{x} ( μ , {σ}^{2} ) = \frac{1}{σ \sqrt{2 π}} exp ( - \frac{{( x - μ )}^{2}}{2 {σ}^{2}} ) \qquad ( 3 )$$

is the normal distribution Nₓ(μ, σ²) of the remainder x with mean at μ and variance of σ², where the variance σ² indicates the variance of the coding bits shaped by the standard rate control algorithm of rate control module 22 of encoder 14, and hence the accuracy of the rate control algorithm. The variance may be selected based on actual data obtained for the rate control algorithm, or may be estimated. It should be noted that the above probability function is normalized from [0, μ] to [0, 1] without loss of generality.

For the normal distribution in the example of FIG. 4, 68.3% of the probability lies within [−σ, σ] around μ, 95.4% of the probability lies within [−2σ,2σ] around μ, and 99.7% of the probability lies within [−3σ,3σ] around μ. Therefore, if it is assumed that σ≦0.5, then the above distribution can be approximated as:

p(x)≈1−A+ANₓ(μ,σ²)+ANₓ(μ−1,σ²) 0≦μ≦1 0≦x≦1. (4)

To achieve minimum packetization overhead, the mean μ of the SF remainder x is maximized as follows:

$$\begin{matrix}E ( x ) \approx \frac{1 - A}{2} + A {\int }_{x = 0}^{1} {xN}_{x} ( μ , {σ}^{2} ) d x + A {\int }_{x = 0}^{1} {xN}_{x} ( μ - 1 , {σ}^{2} ) d x \\ \approx \frac{1 - A}{2} + A {\int }_{x = - ∞}^{1} {xN}_{x} ( μ , {σ}^{2} ) d x + A {\int }_{x = 0}^{∞} ( μ - 1 , {σ}^{2} ) d x \\ = \frac{1 - A}{2} + A {\int }_{x = - ∞}^{1} {xN}_{x} ( μ , {σ}^{2} ) d x + A {\int }_{x = 1}^{∞} ( x - 1 ) {N}_{x} ( μ , {σ}^{2} ) d x \\ = \frac{1 - A}{2} + A {\int }_{x = - ∞}^{1} {xN}_{x} ( μ , {σ}^{2} ) d x + \\ A {\int }_{x = 1}^{∞} {xN}_{x} ( μ , {σ}^{2} ) d x - A {\int }_{x = 1}^{∞} {N}_{x} ( μ , {σ}^{2} ) d x \\ = \frac{1 - A}{2} + A ( μ - {\int }_{x = 1}^{∞} {N}_{x} ( μ , {σ}^{2} ) d x )\end{matrix} \qquad ( 5 )$$

Therefore, in order to maximize E(x), the following function is maximized:

$$f ( μ ) = μ - {\int }_{x = 1}^{∞} {N}_{x} ( μ , {σ}^{2} ) d x \qquad ( 6 )$$

### Depending on the standard deviation of the rate control algorithm in use, which can be estimated from simulation, the value of μ in equation (6) can be used to further fine-tune the rate control target, e.g., as shown in equations (9)-(12) below.

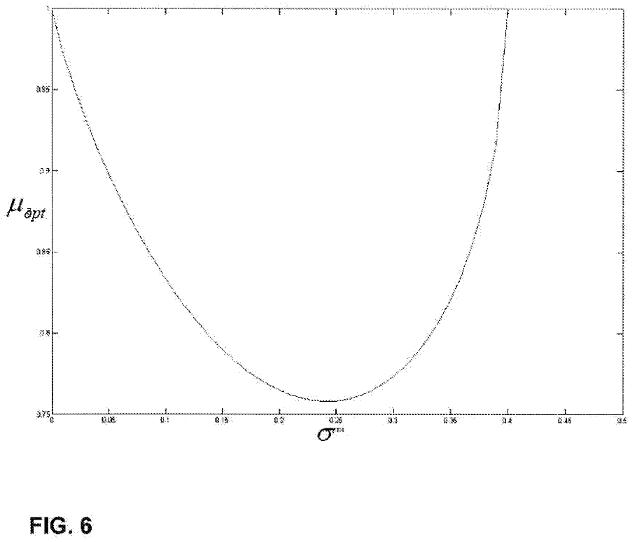

FIG. 5 is a graph that plots the above function ƒ(μ) for the cases of ρ=0, 0.1, 0.2, 0.3, 0.4 and 0.5 for purposes of further illustration. The graph of FIG. 5 shows differences in the function for different variances represented by σ². Hence, to achieve a desired distribution of SF remainders, a different η(μ) curve can be selected for use by rate control module 22, given knowledge of the σ² applicable to the particular encoder 14. For σ≧0.39894228, the maximum of η(μ) is achieved at μ=1, while for smaller σ, the maximum of ƒ(μ) is achieved upon satisfaction of the following criterion:

$$\begin{matrix}0 = \frac{d}{d μ} f ( μ ) \\ = 1 - \frac{d}{d μ} {\int }_{x = 1}^{∞} {N}_{x} ( 0 , {σ}^{2} ) d x \\ = 1 - \frac{d}{d μ} {\int }_{x = 1 - μ}^{∞} {N}_{x} ( 0 , {σ}^{2} ) d x \\ = 1 - {N}_{x} ( 0 , {σ}^{2} ) {\vert}_{x = 1 - μ}\end{matrix} \qquad ( 7 )$$

Given the above, the expression below follows:

$${μ}_{opt} = \{ \begin{matrix}1 & if σ \geq 0.39894228 \\ 1 - {arg}_{x} \{ {N}_{x} ( 0 , {σ}^{2} ) = 1 \} & if σ < 0.39894228\end{matrix} . \qquad ( 8 )$$

The above expression produces the optimum μ that should be selected to achieve a desired distribution of SF remainders that best reduces packetization overhead. Hence, the coding rate selected by rate control module 22 can be continuously or periodically biased so that the optimum μ, or some μ within a predetermined margin of the optimum μ, can be substantially maintained. Again, the μ may be obtained based on static historical data characterizing video segments previously encoded by video encoding module 20, or dynamic historical data that is periodically or continuously updated for video segments actually encoded by video encoding module 20 over time.

FIG. 6 is a graph that plots the relationship between μₒₚₜ and σ in the above expression (8) for purposes of further illustration. The standard deviation σ is determined by the accuracy of the rate control algorithm in use by rate control module 22. If the rate control algorithm can adapt the SF size modulo u histogram such that 0.2≦σ≦0.25, the working point of μ should be selected to be approximately 0.77.

At the frame level of a rate control algorithm, the target frame size is typically designated before the frame is encoded. If it is assumed that this target frame size is Fₜ, after the encoding of a frame, the actual frame size is Fₐ. There is typically a mismatch between Fₜ and Fₐ and the ratio between them is a slowly changing variable. The ratio between Fₜ and Fₐ may be expressed as follows:

$$γ = \frac{{F}_{a}}{{F}_{t}} . \qquad ( 9 )$$

The ratio γ can be estimated y using a linearly weighted function as follows:

$$γ ← ( 1 - α ) γ + α \frac{{F}_{a}}{{F}_{t}} . \qquad ( 10 )$$

where α is a weighting factor having a value that represents the persistency of the current video content. The rate control algorithm implemented by rate control module 22 (FIG. 1) may be configured to perform frame level rate control with the next frame size target as follows:

$${F}_{t} ← u \times round ( \frac{{S}_{SF} + ( γ - 1 ) {F}_{t} - μ u}{u} ) - ( γ - 1 ) {F}_{t} + μ u , \qquad ( 11 )$$

where S_{SF} is the SF size estimated by the rate control module 22, round is the rounding function, and μ is estimated from the peakedness of the SF size modulo u after rate adaptation. By applying the above rate control algorithm, rate control module 22 can achieve lower padding overhead compared to rate control algorithms without rate adaptation.

In the above algorithm, rate control module 22 adjusts the frame level encoding rate based on the target frame size Fₜ. In turn, rate control module 22 determines the target frame size based on the estimated SF size and the packet size u, as well as actual frame size to target frame size ratio γ and the mean μ. In this manner, rate control module 22 compensates for differences between the target frame encoding rate and the actual frame encoding rate. In operation, the rate control algorithm implemented by rate control module 22 sets the rate control target. To maintain high occupation of the last packet, the rate control target can be fine-tuned on a periodic or continuous basis to substantially maintain an optimum μ in the modulo sense. Hence, this fine-tuning of the rate control target can be accomplished by an algorithm that “plugs into” any existing rate control algorithm to fine-tune the rate control target so that the last packet attains the most fullness on average.

It should be noted that SF level rate adaptation applied by rate control module 22 can collaborate with Group Of Picture (GOP) or slice level rate control algorithms to provide added error resilience. For example, if the last frame to be encoded in an SF has a significantly small encoding complexity and there is large leftover bandwidth in u=12 kbits modulo size, the current frame being encoded can adapt the slice size for error resilience. For example, the mode decision can also be adjusted to utilize the leftover bits to improve error resilience. For example, more macroblocks can be coded as Intra instead of Inter to recover from possible channel impairments. In this case, additional coding bits take the place of padding bits. In other words, this techniques permits the number of coding bits in the last packet to be increased versus the number of padding bits.

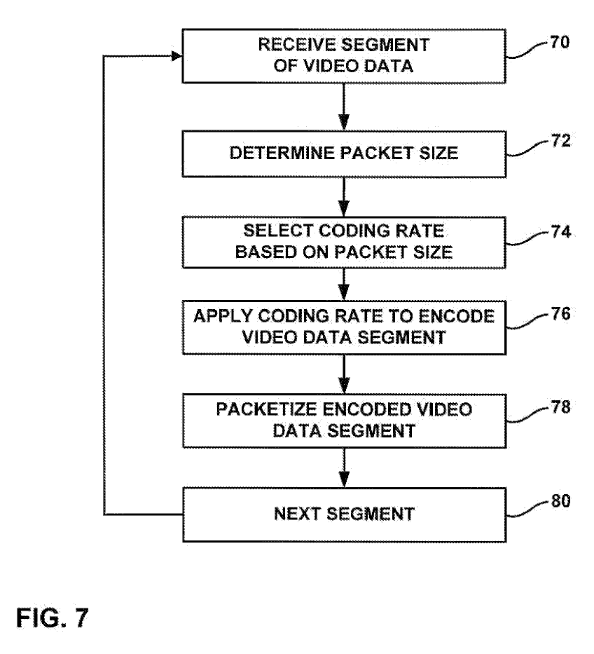

FIG. 7 is a flow diagram illustrating a video encoding method for reducing packetization overhead, in accordance with an aspect of this disclosure. The method of FIG. 7 may be implemented by video processing apparatus 10, and particularly encoding module 20 and rate control module 22 of video encoder 14, and packetizer 16, of FIG. 1. As shown in FIG. 7, encoding module 20 receives a segment of video data from video source 12 (70). Encoding module 20 determines the size of packets (72) produced by packetizer 16, either based on information provided by the packetizer or based on a predetermined packet size assumed to be used by the packetizer.

Upon determining the packet size, rate control module 22 selects a coding rate based on the packet size (74). Encoding module 20 applies the selected coding rate to encode the video data segment (76), and packetizer 16 packetizes the encoded video data segment produced by the encoding module (78). The process then continues to the next segment (90) and repeats. Hence, rate control module 22 adaptively selects the coding rate for each new video segment to be encoded based packet sizes, and thereby reduces packetization overhead.

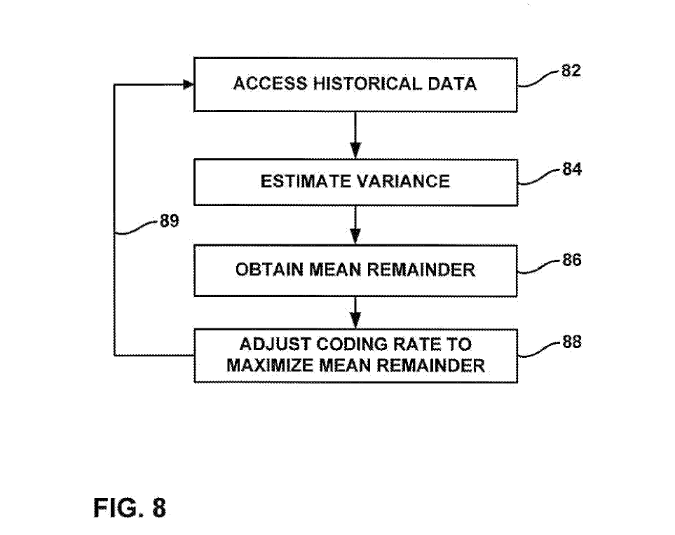

FIG. 8 is a flow diagram illustrating use of historical data to adjust the video coding rate in the method of FIG. 7. In general, FIG. 8 illustrates additional details for selection of the coding rate (74) in the example of FIG. 7. As shown in FIG. 8, for rate control that is responsive to actual video data processed by video processing apparatus 10 during operation, rate control module 22 may obtain or access historical data (82). The historical data indicates a mean value of the remainder for previously encoded segments of digital video data, and may be similar to data plotted in the graph of FIG. 4. Again, the mean value for the previously encoded video segments may be obtained over a sliding window of encoded video segments, and may be analyzed and computed by rate control module 22 of another component within video encoder 14.

Upon estimating the variance of the rate control algorithm used by rate control module 22 (84), rate control module 22 obtains the mean remainder value (86) from the historical data and biases the coding rate to increase the mean size of the remainder for future segments (88), e.g., using equation (6) above. As mentioned previously, the variance may be selected based on actual data obtained for the rate control algorithm, or may be estimated or assumed. Upon adjusting the code rate to maximize or optimize the mean remainder value, the process illustrated in FIG. 8 may repeat for successive video segments to be encoded, as indicated by loop 89.

The techniques described herein may be implemented in hardware, software, firmware, or any combination thereof Various components such as video encoding module 20 and rate control module 22 may be implemented within a video encoder-decoder (CODEC). If implemented in software, the techniques may be directed to a machine readable medium comprising program code or instructions, that when executed in a machine that encodes video sequences, performs one or more of the methods mentioned above. In that case, the computer readable medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, and the like.

The program code or instructions may be stored on memory in the form of computer readable instructions. In that case, a processor such as a DSP may execute instructions stored in memory in order to carry out one or more of the techniques described herein. In some cases, the techniques may be executed by a DSP that invokes various hardware components to accelerate the encoding process. In other cases, the video encoder may be implemented as a microprocessor, one or more application specific integrated circuits (ASICs), one or more field programmable gate arrays (FPGAs), or some other hardware-software combination.

Various aspects have been described. These and other aspects are within the scope of the following claims.

1. A video encoding method comprising:
determining a size of a packet used to packetize an encoded segment of digital video data; and
selecting an encoding rate for the segment of digital video data based on the packet size.

2. The method of claim 1, further comprising:
encoding the segment of digital video data using the selected encoding rate; and
packetizing the encoded segment of digital video data over a series of packets,
wherein the encoded segment of digital video data includes a remainder that fills a portion of a last packet in the series of packets.

3. The method of claim 2, further comprising selecting the encoding rate based on an estimated variance of a rate control algorithm used to encode the segment of digital video data and historical data indicating a mean value of the remainder for previously encoded segments of digital video data.

4. The method of claim 3, wherein selecting the encoding rate comprises selecting the encoding rate to increase a size of the remainder, thereby reducing a number of padding bits required to fill the last packet.

5. The method of claim 1, wherein each of the packets has a fixed packet size.

6. The method of claim 1, wherein the segment includes a plurality of frames, and selecting the encoding rate comprises adjusting the encoding rate based on a variable indicating a difference between a target size of a previously encoded frame of digital video data and an actual size of the previously encoded frame of digital video data.

7. The method of claim 1, further comprising selecting encoding rates for each of a plurality of additional segments of digital video data based on the packet size, encoding the additional segments of digital video data using the selected encoding rates, and packetizing the additional encoded segments of digital video data.

8. A digital video encoding apparatus comprising a rate control unit that determines a size of a packet used to packetize an encoded segment of digital video data, and selects an encoding rate for the segment of digital video data based on the packet size.

9. The apparatus of claim 8, further comprising:
an encoding module that encodes the segment of digital video data using the selected encoding rate; and
a packetization module that packetizes the encoded segment of digital video data over a series of packets,
wherein the encoded segment of digital video data includes a remainder that fills a portion of a last packet in the series of packets.

10. The apparatus of claim 8, wherein the rate control unit selects the encoding rate based on an estimated variance of a rate control algorithm used to encode the segment of digital video data and historical data indicating a mean value of the remainder for previously encoded segments of digital video data.

11. The apparatus of claim 10, wherein the rate control unit selects the encoding rate to increase a size of the remainder, thereby reducing a number of padding bits required to fill the last packet.

12. The apparatus of claim 8, wherein each of the packets has a fixed packet size.

13. The apparatus of claim 10, wherein the segment includes a plurality of frames, and the rate control unit adjusts the encoding rate based on a variable indicating a difference between a target size of a previously encoded frame of digital video data and an actual size of the previously encoded frame of digital video data.

14. The apparatus of claim 8, wherein the rate control unit selects encoding rates for each of a plurality of additional segments of digital video data based on the packet size, the apparatus further comprising an encoding module that encodes the additional segments of digital video data using the selected encoding rates, a packetization module that packetizes the additional encoded segments of digital video data.

15. A processor for encoding digital video data, the processor being configured to determine a size of a packet used to packetize an encoded segment of digital video data, and select an encoding rate for the segment of digital video data based on the packet size.

16. A video encoding apparatus comprising:
means for determining a size of a packet used to packetize an encoded segment of digital video data; and
means for selecting an encoding rate for the segment of digital video data based on the packet size.

17. The apparatus of claim 16, further comprising:
means for encoding the segment of digital video data using the selected encoding rate; and
means for packetizing the encoded segment of digital video data over a series of packets,
wherein the encoded segment of digital video data includes a remainder that fills a portion of a last packet in the series of packets.

18. The apparatus of claim 17, further comprising means for selecting the encoding rate based on an estimated variance of a rate control algorithm used to encode the segment of digital video data and historical data indicating a mean value of the remainder for previously encoded segments of digital video data.

19. The apparatus of claim 18, further comprising means for selecting the encoding rate to increase a size of the remainder, thereby reducing a number of padding bits required to fill the last packet.

20. The apparatus of claim 16, wherein each of the packets has a fixed packet size.

21. The apparatus of claim 16, wherein the segment includes a plurality of frames, the apparatus further comprising means for adjusting the encoding rate based on a variable indicating a difference between a target size of a previously encoded frame of digital video data and an actual size of the previously encoded frame of digital video data.

22. The apparatus of claim 16, further comprising means for selecting encoding rates for each of a plurality of additional segments of digital video data based on the packet size, means for encoding the additional segments of digital video data using the selected encoding rates, and means for packetizing the additional encoded segments of digital video data.

23. A machine-readable medium comprising instructions for video encoding, wherein the instructions upon execution cause a machine to:
determine a size of a packet used to packetize an encoded segment of digital video data; and
select an encoding rate for the segment of digital video data based on the packet size.
